(19) United States
(12) Patent Application Publication
(10) Pub. No.: US 2005/0189453 A1
(43) Pub. Date: Sep. 1, 2005

(54) Cable organizer

(76) Inventor: Orlando DeGuevara, Toluca Lake, CA (US)

Correspondence Address: Kevin M. Able, 2825 Hickock Road, Corning, NY, 14830, US

(21) Appl. No.: 11/107,606

(22) Filed: Apr. 16, 2005

Related U.S. Application Data
(63) Continuation-in-part of application No. 10/621,876, filed on Jul. 16, 2003.

(51) Int. Cl. F16L 3/22; G02B 6/00

(52) U.S. Cl. 248/68.1

(57) ABSTRACT

Disclosed is a cable organizer for organizing and retaining cables including a thin sheet of flexible material having at least one opening adjacent an edge of the material. The cable organizer is further comprised of openings arranged along an edge of the cable organizer and in communication with the edge to allow the passage of a cable into the opening. The openings are sized to to prevent the passage of a cable connector such that a cable connector located on the end of the cable is unable to pass through the opening. Thus, the cable end may be retained by the cable organizer in a convenient position for future re-connection. The cable organizer may also provided with an adhesive strip for adhering the cable organizer to an object.

This application claims the benefit of priority under 35 U.S.C. § 119(e) of U.S. application Ser. No. 10/621,876 filed Jul. 16, 2003, the content of which is relied upon and incorporated herein by reference in its entirety.

### BACKGROUND OF THE INVENTION

1. Field of the Invention

The invention relates to a cable organizer for organizing and holding electrical power and/or data cables.

2. Technical Background

Computers are ubiquitous. Having moved from room-sized enclosures to hand-held devices and smaller, there is virtually not an aspect of daily life that is not touched by computers in one way or another. The markets for computing equipment, and in particular so-called personal, or desktop, computers (PCs) and more portable laptop computers have undergone significant growth over the last decade. Both desktop and laptop computers can be found in home, office and educational environments. Unfortunately, the growth in the number of such computing devices has been matched and exceeded by the amount of peripheral equipment that is or can be commonly attached to the processing unit/enclosure. Peripheral equipment includes input devices such as keyboards and “mice”, scanners, printers, data storage devices, and monitors as well as related data and power cables. The need for peripheral devices, and the accompanying proliferation in cables leading to and from the processor enclosure and power sources, has resulted in a virtual jungle of cables.

To overcome this tangle of electrical and electronic pathways, specially-designed furnishings, such as, for example, computer desks, have been introduced to provide ergonomically correct access to the processor enclosure and peripheral devices. Some of the more elaborate designs may include, for example, cable pass-through ports located in the top of the desk. The appropriate cables, for example the cables to a monitor located on the desktop, are threaded through the pass-through to the processor enclosure and the power outlet. Other desks are provided with raceways that guide the cables through various channels built into the desks. In spite of these advancements, such desks are expensive, and threading the cables through such openings and channels is burdensome, particularly if equipment must be frequently moved and/or re-configured.

In a frequent scenario found in office or educational environments, desktop PCs, in in some cases laptop computers, or individual peripheral devices, are moved, either for replacement or personnel relocation. Frequently, the desk or table on which the peripheral devices rest has no built-in cable routing. When the cables connecting the peripheral devices to the processor enclosure are disconnected, they typically fall to the floor. This can prove to be burdensome in an environment where such changes occur often.

### SUMMARY

In one broad aspect of the present invention, the cable organizer comprises a sheet of flexible material having a first edge, at least one opening disposed adjacent to the first edge, a slot extending between the at least one opening and the first edge to allow a passage of at least one cable, an adhesive disposed on the sheet for adhering the cable organizer to an object, and wherein the cable organizer has a substantially uniform thickness.

Preferably, the cable organizer comprises a plurality of openings adjacent the first edge, each of the plurality of openings having a slot extending from each opening to the first edge. The cable organizer preferably also includes a releasable liner disposed overtop the adhesive to prevent the adhesive from inadvertently adhering to unintended objects. The adhesive may beneficially be disposed adjacent a second edge opposite the first edge.

In its simplest embodiment, the cable organizer is substantially planar. However, the cable organizer may include a hinge, such as a living hinge, to allow the cable organizer to fold along a predetermined line, thus facilitating fastening the cable organizer to such broad objects as a wall, which fastening would otherwise inhibit passing a cable through the opening or slots of the organizer. In yet another embodiment, the cable organizer can be manufactured and rolled or coiled for later cutting into convenient lengths.

The cable organizer according to the present invention is relatively thin and essentially 2-dimensional, having a thickness typically less than about 2 mm. The thickness of the adhesive strip is insignificant compared to the thickness of the overall cable organizer, making the cable organizer a substantially uniform thickness.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is rear view of a typical computer setup, showing peripheral devices and the cable organizer according to one embodiment.

FIG. 2 is a side view of the computer setup showing peripheral devices and the cable organizer according to one embodiment.

FIG. 3 is an illustration of one embodiment of the cable organizer according to the present invention.

FIG. 4 is an illustration of another embodiment of the cable organizer according to the present invention.

FIG. 5 is an edge view of the embodiment according to FIG. 3.

FIG. 6 is an illustration of a cable connector attached to a cable.

FIG. 7 is a perspective view of the cable organizer mounted to a wall and showing the cable organizer bent along the hinge feature so as to provide cable access through the openings.

FIG. 8 is an illustration of another embodiment of the cable organizer according to the present invention wherein the cable organizer is formed in a long length.

FIG. 9 is an illustration of another embodiment of the cable organizer according to the present invention wherein the cable organizer has a circular shape.

FIG. 10 depicts another embodiment of the cable organizer according to the present invention wherein at least a portion of the cable organizer has a circular shape.

### DETAILED DESCRIPTION

In the following, preferred embodiments of the cable organizer in accordance with the present invention will be explained in detail with reference to the drawings. In the explanation of the drawings, constituents identical to each other will be referred to with numerals or letters identical to each other, without repeating their overlapping descriptions. Also, ratios of sizes in the drawings do not always coincide with those explained.

Although various tables, desks, cabinets and other furniture pieces have been designed to accommodate computers and related peripheral equipment, such furniture pieces do not all provide a means for organizing and retaining the data cables and power cables associated with the computer equipment. In addition, such specialized pieces of furniture tend to be expensive compared to their non-computer counterparts, making their use financially burdensome, particularly in environments where a large number of computers are deployed. Thus, often the furniture piece on which the processor enclosure or peripheral device rests has no built-in cable routing or restraint. Consequently, not only do the various processor enclosures, monitors, disk drives, printers, scanners, keyboards and other devices consume considerable space on a given work surface, but the multiple associated data and power cables soon become an unruly tangle. The cable organizer according to the present invention is intended as an inexpensive, easily employed means of bringing much-needed organization to the proliferation of various computer-related cables without the need to resort to more elaborate, specialized furnishings. Additionally, if a cable that connects a peripheral device to the processor enclosure, or one peripheral device to another, or in any event that passes through the cable organizer according to the present invention is disconnected, the connector at an end of such cable is stopped from passing through the opening in the cable organizer. As a result, the cable is held by the cable organizer in a location convenient for re-connection rather than dropping to the floor, under or behind a furnishing. One example of such a situation is a laptop computer, wherein the laptop computer, being disposed on the surface of a desk, is connected to an external power supply, and one or more peripheral devices. The portable laptop is disconnected from the power supply and peripheral devices by disconnecting the power supply and peripheral device cables, and removed from the table. The cables are prevented from falling to the floor by the cable organizer, and are in a ready position to be re-connected to the laptop computer when the computer is returned. Such a scenario frequently occurs in an office or educational environment, most often during the personnel relocations. In such instances, computer peripheral devices, the processor enclosure, or all such components may require replacement or otherwise be moved to another location.

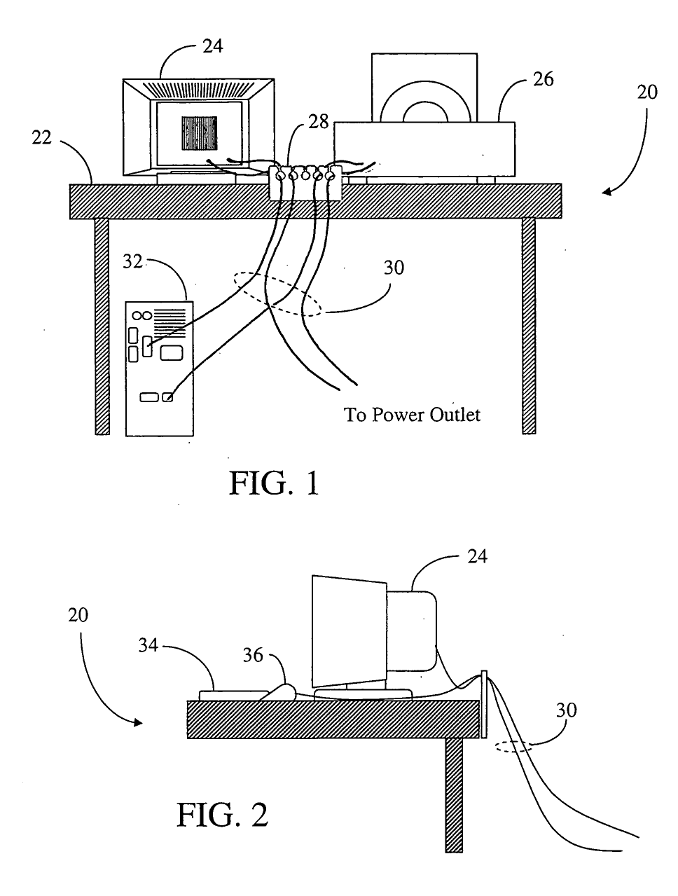

A typical layout of a minimal amount of computer equipment on the top work surface of a table is illustrated in FIG. 1. FIG. 1 shows a rear view of table 20 supporting on its top work surface 22 a computer monitor 24 and printer 26. Preferably, the layout would include a keyboard and “mouse” (not shown in FIG. 1). A preferred embodiment of the cable organizer 28 according to the present invention is shown attached to the back edge of table 20. Data and power cables 30 are shown exiting both monitor 24 and printer 26 and passing through cable organizer 28. Such cables either terminate at the processor enclosure 32, or at a power outlet (not shown). Processor enclosure 32 typically comprises the central processing unit (CPU) mounted on a so-called motherboard, one or more magnetic data storage devices (“hard drives”), and one or more optical data storage or retrieval drives (such as compact disk drives), and an internal power supply/regulator for the motherboard, CPU and other components typically, although not exclusively, located within the processor enclosure. FIG. 2 shows an end view of table 20, along with computer monitor 24. Also shown in FIG. 2 are computer keyboard 34 and “mouse” 36 (in this context a “mouse” refers to a hand-held input device used to control, inter alia, a cursor on the computer monitor). In FIG. 2, cable organizer 28 is shown attached vertically to the vertical back edge of table 20. Also shown are several computer cables 30 passing from monitor 24 and mouse 36 through cable organizer 28. It will be readily apparent that cable organizer 28 could be easily attached to table 20 in other orientations, such as, for example, in a horizontal configuration to the top work surface 22 of table 20.

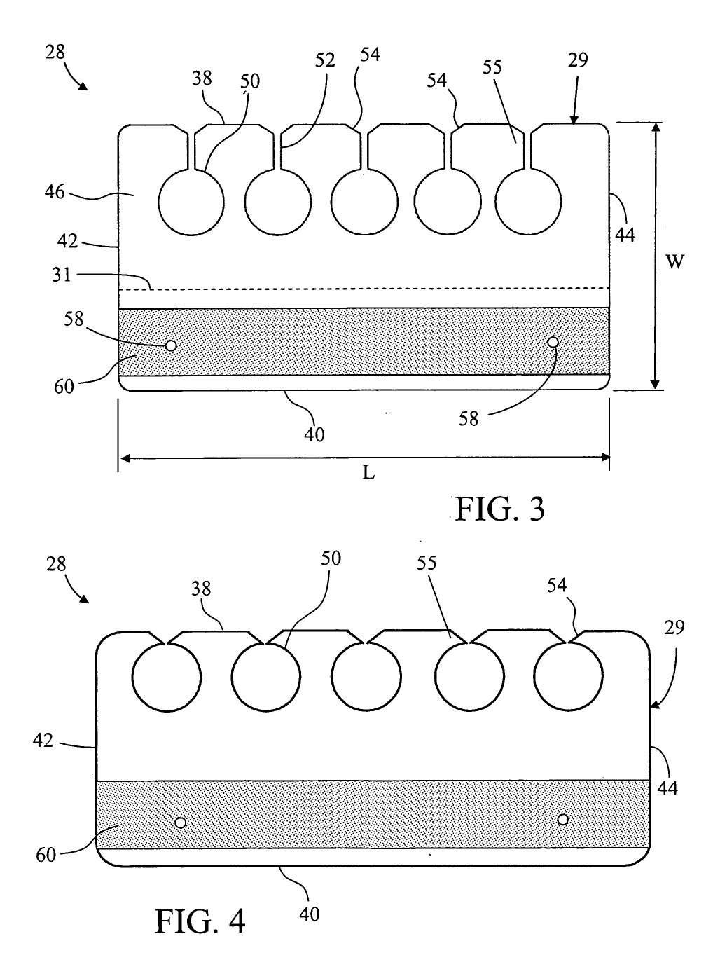

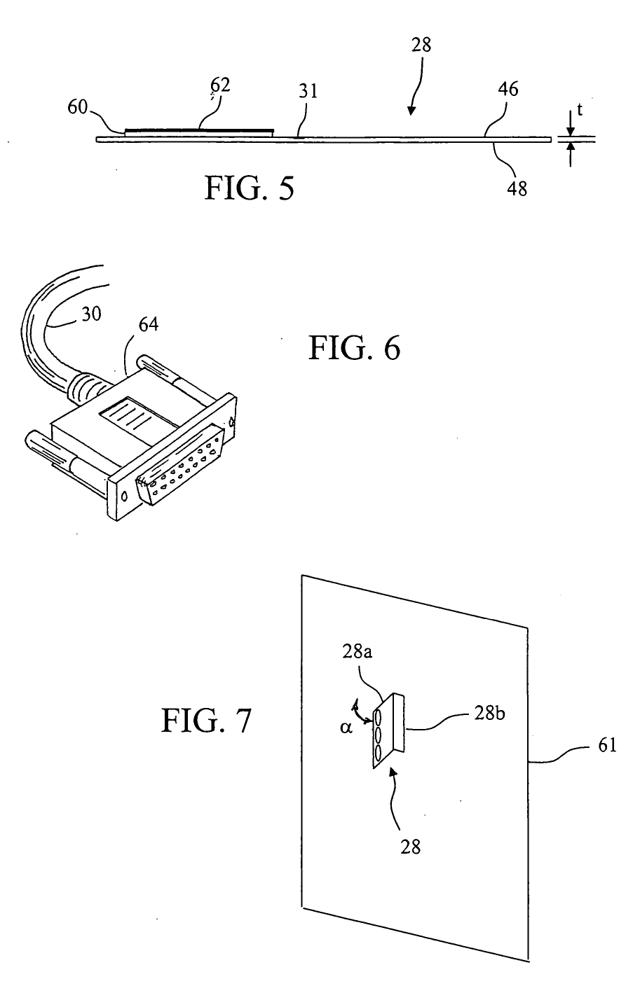

Referring to FIG. 3, cable organizer 28 according to one embodiment is comprised of a thin sheet 29 formed from a flexible material having a generally rectangular shaped perimeter defined by a width W between a first outside side edge 38 and a second outside side edge 40, and a length L between a first outside end edge 42 and a second outside end edge 44. Sheet 29 has a first face 46 and a second face 48 (shown in FIG. 5), and at least one opening 50 between the first face 46 and the second face 48 therethrough, the opening 50 being sized to fit at least one data, telephony or power cable, and also sized to prevent the passage of a cable connector disposed on at least one end of cable 30. Openings 50 are arranged adjacent to the first side edge 38 of cable organizer 28. Preferably length L of cable organizer 28 is less than about 25 cm, more preferably less than about 15 cm, most preferably less than about 10 cm. Preferably, the aspect ratio of cable organizer 28, that is, length L divided by width W, is greater than 1. Preferably, cable organizer 28 is comprised of a cardboard stock, more preferably a polymer. Preferred polymers include, for example, polyester, polyethylene or polypropylene.

The at least one opening 50 is in communication with side edge 38. That is, opening 50 is connected to edge 38 such that a cable may pass through the line of the edge into opening 50. For example, as shown in the embodiment illustrated in FIG. 3, opening 50 may be connected with outside edge 38 through slot 52 extending from the at least one opening 50 to first side edge 38. In another embodiment shown in FIG. 4, opening 50 is in communication with edge 38 without the need for a distinct slot, i.e. opening 50 intersects edge 38. Preferably, the first side edge 38 of cable organizer 28 has a chamfer 54 to facilitate guiding a cable 30 into opening 50.

Cable organizer 28 may be attached to a selected object, such as a household furnishing, by mechanical fastening through “nail” openings 58. Any suitable mechanical fastener may be employed that can pass through openings 58 such as nails or thumbtacks. Obviously, such fasteners are effective only in mounting cable organizer 28 on an object into which the fastener can be driven, for example a wooden desk. However, such methods of fastening may cause damage to the furnishing. In a preferred embodiment, an adhesive strip 60 is provided on a first face 46 of cable organizer 28 generally adjacent to and parallel with the second side edge 40 and opposite first side edge 38. Adhesive strip 60 is preferably covered with a releasable liner 62 (shown in FIG. 5) to prevent inadvertent adhesion.

As shown in FIG. 5, cable organizer 28 according to the present embodiment is relatively thin, having a thickness t which is preferably less than about 2 mm; more preferably less than about 1 mm. Advantageously, thickness t is substantially uniform, varying only by the thickness of the adhesive strip (shown greatly exaggerated for clarity), which has a thickness much less than the overall thickness of the organizer (e.g. at most, a few tenths of a millimeter). Thus, cable organizer 28 does not require or incorporate additional structural stiffening members, such as flanges, and is simple and inexpensive to manufacture. In a preferred embodiment, cable organizer 28 is substantially planar. However, the lack of stiffening members beneficially allows the cable organizer to be manufactured and/or sold in long rolls having a plurality of holes, after which end users may cut the cable organizer to an appropriate length (depending upon the number of openings desired, for example). In addition, the flexibility of cable organizer 28 may allow the cable organizer to be mounted on non-planar surfaces, such as the curved edge of a circular table for example, wherein the cable organizer conforms to the curvature of the circular edge surface of the table top.

In a preferred embodiment, adhesive strip 60 comprises a double-sided adhesive tape wherein one side of the tape is applied to first face 46. The opposite, otherwise exposed side of the tape is preferably protected by releasable liner 62. Such adhesive tapes are generally comprised of an elongated flexible backing material and an adhesive which has been applied to one or both sides of the backing material. FIG. 5 depicts an end edge view of the cable organizer of FIG. 3 showing adhesive strip 60 and releasable liner 62. Because home or work place furnishings may be constructed from a variety of materials, adhesive strip 60 is preferably capable of adhering to a variety of surfaces with high adhesion, including, for example, wood, metal and plastic. In addition, because cable organizer 28 is preferably comprised of low surface energy polymers such as polyethylene, the preferred adhesive comprising adhesive strip 60 should also be capable of adhering to such low surface energy materials. Examples of suitable adhesive tapes include 3M™ Double Coated Tape 444, employing an acrylic adhesive on a polyester backing, and 3M™ Double Coated Tape 9443, employing a synthetic rubber adhesive on a polypropylene backing. 3M™ Double Coated Tape 444, for example, has an adhesive strength of about 47 N/100 mm when tested according to ASTM 3330 after 72 hours at room temperature and at an angle of 90 degrees on polypropylene, and 66 N/100 mm on polyester and stainless steel. 3M™ Double Coated Tape 9443, on the other hand, has an adhesive strength of 110 N/100 mm on steel. For added adhesion, the adhesive preferably should have an adhesive strength greater than about 80 N/100 mm, such as, for example, 3M Adhesive Transfer Tape 9453, 9471 or 9472. These adhesive tapes comprise a high-strength acrylic adhesive on a polycoated kraft liner. Transfer tape 9472 is rated to have an adhesive strength of 81 N/100 mm when tested in accordance to ASTM 3330 after 72 hours at room temperature and at an angle of 90 degrees on polypropylene, and 82 N/100 mm on stainless steel, whereas 3M Adhesive Transfer Tape 9472 is rated to have an adhesive strength of 149 N/100 mm on polypropylene and 153 N/100 mm on stainless steel. Preferably, the adhesive strength of the adhesive is at least 45 N/100 mm, more preferably greater than about 80 N/100 mm, and most preferably greater than about 100 N/100 mm. Although an adhesive tape is preferred, those skilled in the art will recognize that other adhesive choices can be made, such as, for example, an adhesive applied as a liquid.

To deploy the cable organizer according to the present invention when an adhesive strip is used, releasable liner 62 is peeled away from adhesive strip 60, exposing adhesive strip 60. Cable organizer 28 is then pressed against the desired surface, such as, for example, an edge of table 20, such that exposed adhesive strip 60 is in contact with the surface to which cable organizer 28 is to be attached. It should be noted that cable organizer 28 need not be used only in conjunction with a table edge. Cable organizer 28 may be easily deployed on a variety of different surfaces and furnishings as the need arises. For example, cable organizer 28 may be easily deployed on a table leg, the side of a cabinet, or anywhere cable organization and retention is desired. Cable organizer 28 may be deployed in any number of orientations, including horizontally and vertically. Furthermore, cable organizer 28 need not be restricted to use for computer data and power cables. For example, cable organizer 28 is also useful for such applications as the organization and retention of sound and/or video recording and playback equipment cables. Such equipment comprises amplifiers, tuners, phonographs, tape players, compact disc (CD) players, equalizers, Digital Video Disc players (DVD), televisions, video tape players and others.

Once cable organizer 28 has been adhered in a suitable location for organizing and retaining the desired cable or cables, the cables may be inserted into cable organizer 28 by pressing a selected cable or cables 30 between chamfers 54 and through slot 52. Tabs 55 (FIG. 1) may be bent aside, if necessary, to allow the cable to pass through into opening 50. Additional cables may be inserted, as needed, in the manner just described. Computer cables (both data and power cables) typically are configured with a connector located at one or both ends of the cable to facilitate mating with a corresponding connector on a piece of equipment. An exemplary connector 64 located at the end of a cable 30 is depicted in FIG. 6. Openings 50 are preferably sized such that connector 64 is unable to pass through an opening 50. In this instance, connector 64, and therefore cable 30, being disconnected from a peripheral device, will be retained by opening 50 at the cable organizer 28, placing cable 30 and connector 64 in a convenient location for re-connection.

Cable organizer 28 may further include a foldable portion which may be bent at an angle, thereby allowing the cable organizer to be attached to a large planar object, such as a wall. As illustrated in FIG. 3, sheet 29 may include an optional scoring or hinge feature 31 (e.g. a living hinge), which preferably runs generally parallel to side edge 40 opposite the at least one hole. This hinge feature 31 divides cable organizer 28 into a first, body portion 28a (FIG. 7) and a second, foldable portion 28b, and facilitates the bending (folding) of body portion 28a relative to foldable portion 28b. Hinge feature 31 may be, for example, a narrow, shallow channel (score) in sheet 29 which runs parallel to one or both side edges 38, 40. Foldable portion 28b includes adhesive strip 60 and removable liner 62 releasable adhered thereto. As in the case of adhesive strip 60 and removable liner 62, the difference in thickness of the cable organizer at the hinge portion relative to the overall thickness of the cable organizer is insignificantly small. More simply put, with the exception of the small differences in thickness due to the adhesive strip and releasable liner and/or hinge feature 31, the cable organizer according to the present invention has a substantially uniform thickness.

To attach cable organizer 28 to a wall, for example, foldable portion 28b is bent through an angle α relative to body portion 28a. Preferably, a is less than about 90 degrees relative to the plane of body portion 28a. Releasable liner 62 is removed from adhesive strip 60, after which the adhesive strip is pressed against the desired object. Advantageously, with body portion 28a forming an angle α with foldable portion 28b, body portion 28a may be positioned to project away from the object to which it is attached, therefore providing access to hole 50. FIG. 7 is a perspective view of the cable organizer in such a configuration, attached to wall 61.

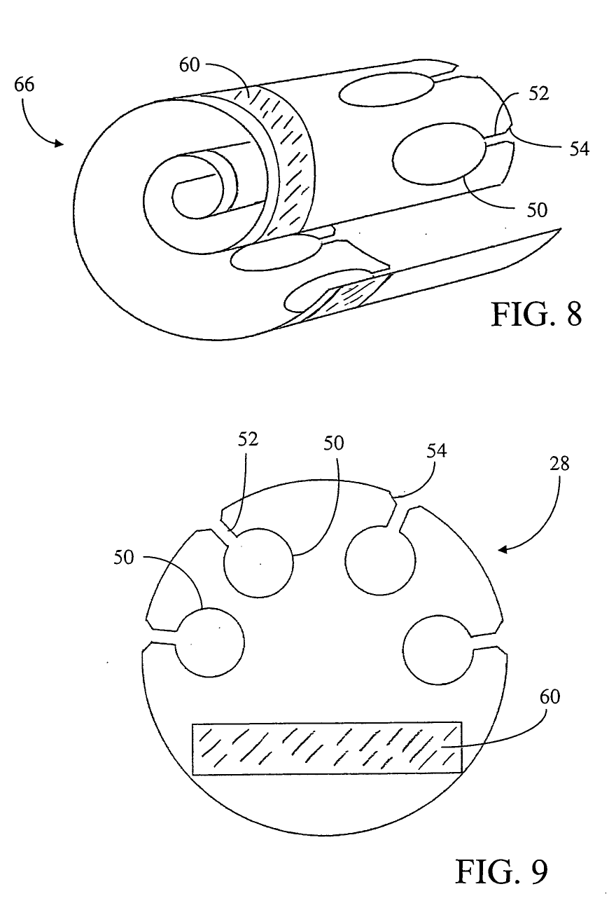

As described above, the length L of cable organizer 28 may be much longer than width W of cable organizer 28, thus forming a long-length cable organizer 66 which may be conveniently rolled for storage, as illustrated in FIG. 8. In this embodiment, individual shorter cable organizers 28 of a desired length can be cut from long length cable organizer 66. Preferably, long length cable organizer 66 has an aspect ratio greater than 5, more preferably greater than 20, more preferably greater than 50.

The cable organizer according to the present invention may be manufactured by any suitable method. For example, the cable organizer may be die-cut from an appropriately-sized blank of the flexible material, or it may be injection molded. The choice of manufacturing method is dictated somewhat by the choice of flexible material and the manufacturing cost. For example, the use of cardboard stock necessitates a method employing cutting, such as die cutting (stamping), whereas the choice of a polymer as the flexible material allows either die-cutting or injection molding. Preferably, cable organizer 28 or long length cable organizer 66 is manufactured by injection molding, more preferably by die-cutting.

It should be understood that cable organizer 28 may be manufactured in shapes other than rectangular. For example, cable organizer 28 could comprise a circular shape having a plurality of openings along at least a portion of the edge at the outer circumference of the cable organizer as shown in FIG. 9. FIG. 9 shows one embodiment of a circular cable organizer according to the present invention, including a preferred placement of adhesive strip 60. In this embodiment, cable organizer 28 is comprised of a flexible material having a generally circular shape. Cable organizer 28 is further comprised of a plurality of openings 50 arranged adjacent to at least a portion of the edge at the outer circumference of cable organizer 28. As in the previous embodiment, slots 52 may be used to connect openings 50 to the outer circumference of cable organizer 28. Slots 52 have chamfers 54 at each side of slots 52 at the outer circumference of cable organizer 28. Again, lots 52 are not necessary, and openings 50 may be in physical communication with the outside edge of the organizer in the manner depicted in FIG. 4. Cable organizer 28 according to the present embodiment has an adhesive strip 60 as in the previous embodiment. Preferably adhesive strip 60 is located across a chord of the generally circular cable organizer of the embodiment.

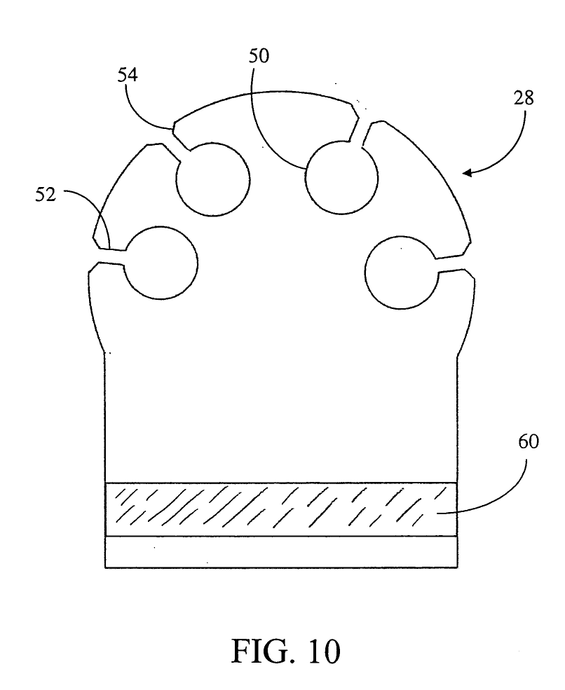

In yet another embodiment, cable organizer 28 may comprise a combination of shapes, such as, for example, at least a portion of a rectangle and at least a portion of a circle, as shown in FIG. 10. As in the previous embodiments, the cable organizer according to the present embodiment is preferably configured with openings 50 along the edge of the portion of a rectangle or the edge at the outer circumference of a circle of the thin, flexible material. Slots 52 may be used to allow passage of at least one cable 30 into openings 50, or openings 50 may be in communication with an outside edge of the cable organizer in the manner depicted in FIG. 4. Chamfers 54 may be included to aid in placing the cables 30 into openings 50. Adhesive strip 60 may then be used to adhere the cable organizer to an appropriate object.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A cable organizer comprising:
a sheet of flexible material having a first edge;
at least one opening disposed adjacent to and in communication with the first edge;
an adhesive disposed on the sheet for adhering the cable organizer to an object; and
wherein the cable organizer has a substantially uniform thickness.

2. The cable organizer according to claim 1 wherein the cable organizer is substantially planar.

3. The cable organizer according to claim 1 wherein the at least one opening intersects the first edge.

4. The cable organizer according to claim 1 wherein the sheet comprises a plurality of openings adjacent the first edge, each of the plurality of openings in communication with the first edge.

5. The cable organizer according to claim 1 further comprising a releasable liner disposed overtop the adhesive.

6. The cable organizer according to claim 1 wherein the cable organizer includes a hinge extending along a length of the sheet for bending a first portion of the cable organizer relative to a second portion of the cable organizer.

7. The cable organizer according to claim 1 wherein the cable organizer is coiled.

8. The cable organizer according to claim 1 wherein the thickness of the cable organizer is less than about 2 mm.

9. The cable organizer according to claim 1 wherein the adhesive is disposed adjacent a second edge opposite the first edge.

10. The cable organizer according to claim 1 wherein the at least one opening is in communication with the first edge through a slot.

11. A cable organizer consisting essentially of:
a sheet of flexible material having at least one edge;
at least one opening disposed adjacent to the edge, the opening in communication with the edge to allow a passage of at least one cable;
an adhesive disposed on the sheet;
a releasable liner disposed overtop the adhesive; and
wherein the cable organizer has a substantially uniform thickness.

12. The cable organizer according to claim 11 wherein the thickness of the cable organizer is less than about 2 mm.

13. A cable organizer comprising:
a sheet of flexible material having at least one edge, the sheet having a first portion and a second portion;
at least one opening disposed adjacent to the edge, the opening in communication with the edge to allow a passage of at least one cable;
an adhesive disposed on the sheet for adhering the cable organizer to an object; and
a hinge extending along a length of the sheet for bending the first portion relative to the second portion.

14. The cable organizer according to claim 13 wherein a thickness of the organizer is substantially uniform.

15. The cable organizer according to claim 14 wherein the thickness of the organizer is less than about 2 mm.

16. The cable organizer according to claim 13 further comprising a removable liner disposed overtop the adhesive.

17. The cable organizer according to claim 13 wherein the cable organizer is coiled.

18. The cable organizer according to claim 13 wherein the cable organizer is substantially planar.

19. The cable organizer according to claim 13 wherein the at least one opening intersects the edge.

20. The cable organizer according to claim 13 wherein the at least one opening is in communication with the edge through a slot.
